(19) United States
(12) Patent Application Publication
(10) Pub. No.: US 2008/0022899 A1
(43) Pub. Date: Jan. 31, 2008

(54) Method for producing powder coating composition

(75) Inventors: Tomoya Tsuji, Osaka (JP); Shunichi Endou, Osaka (JP)

Correspondence Address: BIRCH STEWART KOLASCH & BIRCH, PO BOX 747, FALLS CHURCH, VA, 22040-0747, US

(73) Assignee: NIPPON PAINT CO., LTD.

(21) Appl. No.: 11/826,770

(22) Filed: Jul. 18, 2007

(30) Foreign Application Priority Data
Jul. 31, 2006 (JP) 2006-208257

(51) Int. Cl. C08K 3/34; C08K 3/08; C08K 3/40

(52) U.S. Cl. 106/404; 106/417

(57) ABSTRACT

A method for producing a powder coating composition comprising mixing two or more powder coatings, wherein at least two powder coatings out of the two or more powder coatings have different hues from each other, and wherein each of the two powder coating comprises a flaky pigment bound to a surface of a resin powder comprising a resin and a colorant via a binder having adhesion. The powder coating composition is suitably used in coatings of automobile parts, electric appliances, furniture, engineering work machines, office equipments, toys, and the like, and a method for producing the powder coating composition.

### BACKGROUND OF THE INVENTION

1. Field of the Invention

The present invention relates to a powder coating composition and a method for producing the powder coating composition. More specifically, the present invention relates to a powder coating composition which can be used in coatings of automobile parts, electric appliances, furniture, engineering work machines, office equipments, toys, and the like, and a method for producing the powder coating composition.

2. Discussion of the Related Art

As a low-pollution paint without using an organic solvent, there are increasing demands for a powder coating to be used in automobile parts, electric appliances, furniture, engineering work machines, office equipments, toys, and the like. Since coating with a powder coating not only is low-pollution type, but also gives a thick coating film formed in a single coating, recoating is not necessary for repeated times as in a conventional solvent-based paint, so that the coating time can be shortened. Further, since the paint does not contain a solvent, there is also an advantage such as a pinhole is not generated in the coating film.

In view of the above, a powder coating from which coating films having various external appearances such as metallic effect and pearl-like tones are obtained is earnestly desired suiting their applications. For example, as a powder coating from which a coating film having a metallic effect is obtained, a powder coating composition having a metallic effect, containing a thermosetting resin powder on the surface of which a flaky pigment is bound to the surface of the resin powder via a binder provided with stickiness has been developed (see WO 2002/094950).

On the other hand, as a method for preparing a powder coating to obtain a coating film having a wide range of hues is obtained with a smaller number of assortment of powder coatings, a technique of mixing two or more powder coatings having different hues from each other has been studied (see Japanese Patent Laid-Open No. Hei 10-219412). However, when the toning of the powder coating to obtain a coating film having brightness such as a metallic effect or a pearl-like tone is obtained is carried out, it is necessary to adjust not only the hue but also the brightness at the same time; therefore, the toning is not actually easily carried out in a powder coating having low productivity as compared to that of a solvent-based coating.

### SUMMARY OF THE INVENTION

The present invention relates to:

[1] a method for producing a powder coating composition including the step of mixing two or more powder coatings, wherein at least two powder coatings out of the two or more powder coatings have different hues from each other, and wherein each of the two powder coatings contains a flaky pigment bound to a surface of a resin powder containing a resin and a colorant via a binder having adhesion; and
[2] a powder coating composition containing two or more powder coatings, wherein at least two powder coatings out of the two or more powder coatings have different hues from each other, and wherein each of the two powder coatings contains a flaky pigment bound to a surface of a resin powder containing a resin and a colorant via a binder having adhesion.

### DETAILED DESCRIPTION OF THE INVENTION

The present invention relates to a powder coating composition which can be toned into a wide range of hues with a smaller number of assortment of powder coatings, thereby providing a coating film having brightness such as a metallic effect or a pearl-like tone, and a method for producing the powder coating composition.

These and other advantages of the present invention will be apparent from the following description.

According to the present invention, a powder coating composition to give a coating film having various hues, having brightness of a metallic effect or pearl-like effect, is obtained can be conveniently obtained with a smaller number of assortment of powder coatings, by mixing at least two powder coatings having different hues from each other.

The powder coating composition of the present invention is obtained by mixing at least two powder coatings having different hues from each other, wherein each of the two powder coatings contains a flaky pigment bound to a surface of a resin powder containing at least a resin and a colorant via a binder having adhesion.

As the resin to be contained in the resin powder, a conventionally known resin can be used without particular limitation. The resin includes, for example, non-reactive resins such as polyethylenes, nylon resins, and vinyl chloride; reactive resins such as epoxy resins, polyester resins, and acrylic resins; and the like. These resins can be used alone or in admixture of two or more kinds. Among them, the polyester resins, the epoxy resins, and the acrylic resins are preferable, and it is more preferable that the resin contains a polyester resin and/or an epoxy resin as a main component in an amount of from 50 to 100% by weight of the total amount of the resin.

As the colorant, all of inorganic pigments and organic pigments ordinarily used in powder coatings can be used. The inorganic pigment includes, titanium oxide, red iron oxide, chromium titanium yellow, yellow iron oxide, carbon black, and the like. The organic pigment includes azo-based pigments, perylene-based pigments, condensed azo-based pigments, nitro-based pigments, nitroso-based pigments, phthalocyanine-based pigments, anthraquinone-based pigments, quinacridone-based pigments, dioxane-based pigments, and the like. Specifically, the azo-based pigment includes Lake Red, Fast Yellow, Disazoyellow, Permanent Red, and the like; the nitro-based pigment includes Naphthol Yellow, and the like; the nitroso-based pigment includes Pigment Green B, Naphthol Green, and the like; the phthalocyanine-based pigment includes Phthalocyanine Blue, Phthalocyanine Green, and the like; the anthraquinone-based pigment includes Indanthrene Blue, Dianthraquinonyl Red, and the like; the quinacridone-based pigment includes Quinacridone Red, Quinacridone Violet, and the like; and the dioxane-based pigment includes Carbazole Dioxane Violet, and the like. The amount of the colorant contained differs depending on its kinds. It is preferable that the inorganic pigment is contained in an amount of from 1 to 60 parts by weight, and that the organic pigment is contained in an amount of 0.05 to 30 parts by weight, based on 100 parts by weight of the resin.

When the resin powder contains a reactive resin, the resin powder may contain a curing agent. As the curing agent, any of conventionally known curing agents corresponding to a functional group of the reactive resin used can be used without particular limitations. The curing agent includes, for example, polyisocyanate-based curing agents such as tolylene diisocyanate and xylylene diisocyanate; isocyanurate-based curing agents such as 1,3,5-triglycidyl isocyanurate; blocked isocyanate-based curing agents; epoxy-based curing agents such as bisphenol A diglycidyl ether; alkoxysilane-based curing agents; polyaziridine-based curing agents; oxazoline-based curing agents; β-hydroxyalkylamide curing agents; and the like. The amount of the curing agent to be contained depends upon the amount of functional groups existing in the resin. It is preferable the amount is in the range of from 0.8 to 1.2 in terms of equivalency ratio of the functional groups.

The resin powder may further optionally contain an additive such as a fluidity additive such as an acrylate polymer, a cross-linking accelerator such as various catalysts or an organotin compound; a surface conditioning agent, a plasticizer, an ultraviolet absorbent, an antioxidant, an antistatic agent, or a pinhole preventive such as benzoin.

The powder coating used in the present invention can be prepared by, for example, melt-kneading a resin, a curing agent, a colorant, an additive, or the like with an extruder or the like, cooling the extruded product, subjecting the cooled product to a physical pulverization with a pulverizer such as a hammer-mill or a jet impact mill, and classifying the pulverized product with a classifier such as an air classifier or a micron classifier.

The resin powder has an average particle size of preferably 5 μm or more, from the viewpoint of preventing powder coatings from being aggregated to each other during coating, and the resin powder has an average particle size of preferably 100 μm or less, from the viewpoint of maintaining the smoothness of a surface of a coating film. From these viewpoints, the resin powder has an average particle size of preferably from 5 to 100 μm, and more preferably from 15 to 60 μm.

The flaky pigment to be bound to a surface of the resin powder via a binder having adhesion is preferably a flaky pigment made of at least one member selected from the group consisting of metals, mica, and glass. In these flaky pigments, a metallic flake gives the powder coating brightness of a metallic effect or interference color (retroreflectivity), and a mica flake and a glass flake give the powder coating brightness of a pearl-like tone by binding the flake to the powder coating. The term “flaky” as used herein refers to a small lump of a solid having an average particle size of from 1 to 150 μm, and the average particle size of a flaky pigment refers to an average particle size of a major axis, which corresponds to a 50% value in a particle size distribution on a volume basis, determined with a laser diffraction particle size distribution analyzer.

The metallic flake includes metallic flakes made of a metal such as aluminum, zinc, copper, nickel, titanium, or stainless steel; or an alloy made of bronze, stainless steel, or the like. Among these pigments, the aluminum flake is especially preferable because the aluminum flake has excellent metallic gloss, is inexpensive, and has a small specific gravity, thereby making it easily handleable.

The metallic flake has an average particle size (D₅₀) of preferably from 2 to 60 μm.

The mica flake may be colored. The mica flake includes, for example, various mica pigments known to one of ordinary skill in the art, such as interference mica pigments, colored mica pigments, and metal oxide-coated mica pigments. Further, in the present invention, a hologram pigment is also considered to be included in the mica pigments.

The size of the mica flake is not particularly limited. A mica pigment having flake-like shape and light interference, the mica flake having an average particle size (D₅₀) of from 2 to 50 μm and a thickness of from 0.1 to 5 μm is preferable. A mica flake having an average particle size of from 10 to 35 μm is more preferable, from the viewpoint of brightness.

The glass flake is preferably at least one member selected from the group consisting of metal oxide-coated glass flakes and metal-plated glass flakes. These glass flakes can be used alone or in a combination of two or more kinds. The metal oxide-coated glass flake refers to a glass flake of which surface is coated with a metal oxide such as titanium oxide, and the metal-plated glass flake refers to a glass flake of which surface is plated with a metal such as silver or nickel.

The glass flake has an average particle size of preferably 10 μm or more, from the viewpoint of brightness, and the glass flake has an average particle size of preferably 80 μm or less, from the viewpoint of an appearance of a coating film. From these viewpoints, the glass flake has an average particle size of preferably from 10 to 80 μm, and more preferably from 10 to 60 μm. In addition, the glass flake has an average thickness of preferably from 0.1 to 10 μm, and more preferably from 0.1 to 5 μm.

The amount of the flaky pigment, such as a metallic flake, a mica flake, or a glass flake, contained in the powder coating (weight ratio of solid content of the pigment, based on 100 parts by weight of the solid content of the powder coating: PWC) is preferably 0.01% by weight or more, from the viewpoint of exhibiting brightness accompanying high luminance with glitter in both of high-light portions and shade portions, and the amount of the flaky pigment to be contained is preferably 30% by weight or less, from the viewpoint of an appearance of a coating film. From these viewpoints, the above amount of the flaky pigment to be contained is preferably from 0.01 to 30% by weight, and more preferably from 1 to 20% by weight.

The above flaky pigment could be bound to each powder coating alone, or plural kinds of flaky pigments can be used together in each powder coating. The powder coating composition of the present invention preferably contains a flaky pigment made of a metal which is bound to a surface of a resin powder, and a powder coating in which a flaky pigment made of mica or glass is bound to a surface of a resin powder, from the viewpoint of design.

It is preferable that the binder having adhesive property (adhesion) for binding a flaky pigment to a surface of a resin powder is dissolved in a solvent and used; therefore, it is preferable that the binder has such properties of being completely dissolved in a solvent, having a low viscosity when dissolved in a solvent, and further being solidified when a solvent is removed therefrom in the necessity of suppressing blocking, thereby losing its adhesion.

A binder having adhesion that has properties as mentioned above includes a resin of which number-average molecular weight and softening temperature are adjusted within specified ranges, and the like.

The above resin has a number-average molecular weight of preferably 300 or more, from the viewpoint of preventing the powder coatings themselves in which a flaky pigment is bound to a resin powder from being blocked, and the resin has a number-average molecular weight of preferably 2,000 or less, from the viewpoint of accelerating homogeneous penetration and dispersion into the resin powder when a flaky pigment is bound to a resin powder. From these viewpoints, the resin has a number-average molecular weight of preferably from 300 to 2,000, and more preferably from 400 to 1,500.

In addition, the above resin has a softening temperature of preferably 30° C. or higher, from the viewpoint of preventing the powder coatings themselves in which a flaky pigment is bound to a resin powder from being blocked, and the resin has a softening temperature of preferably 180° C. or lower, from the viewpoint of accelerating homogeneous penetration and dispersion into the resin powder when a flaky pigment is bound to a resin powder. From these viewpoints, the resin has a softening temperature of preferably from 30° to 180° C., and more preferably from 80° to 150° C.

In the present invention, the binder includes natural resins such as coumarone indene-based resins, terpene-based resins, terpene phenolic resins, aromatic hydrocarbon-modified terpene-based resins, terpene-based hydrogenated resins, terpene phenolic hydrogenated resins, rosin-based resins, hydrogenated rosin ester-based resins, rosin-modified phenolic resins, and alkylphenolic resins; synthetic resins such as alkylphenol acetylene-based resins, alkylphenol formaldehyde-based resins, styrenic resins, aliphatic petroleum resins, alicyclic petroleum resins, copolymer-based petroleum resins, aromatic petroleum resins, xylylene-based resins, and xylene formaldehyde-based resins; oligomer-based stickiness-imparting agent such as polybutenes and liquid-based rubbers; and the like. Besides them, various rubber materials, a fat or oil, a wax, or the like can be preferably used as a binder having adhesion. Among them, as a binder having appropriate adhesion in the present invention, a terpene-based resin, a terpene phenolic resin, a terpene-based hydrogenated resin, and a terpene phenolic hydrogenated resin are preferable.

The amount of the binder having adhesion to be formulated is preferably 0.1% by weight or more, of the resulting powder coating, from the viewpoint of preventing a flaky pigment from being released, and the amount of the binder formulated is preferably 5% by weight or less, from the viewpoint of preventing blocking. From these viewpoints, the amount of the binder to be formulated is preferably from 0.1 to 5% by weight of the resulting powder coating.

The method of binding a flaky pigment to a surface of a resin powder via a binder having adhesion is not particularly limited, and includes, for example, the following method. Specifically, a solution prepared by dissolving a binder having adhesion in a solvent is added to a mixture of a resin powder and a flaky pigment which are previously homogeneously mixed, and the mixture obtained is kneaded. Kneading is continued until the solvent is evaporated, and the entire mixture is allowed to be powdered to completely remove the solvent from the mixture, and thereafter the powder is classified with a jet classifier (screen) to give a powder coating. In this method, the binding force between the flaky pigment and the resin powder is increased and at the same time the blocking of the resin powders with each other can be suppressed by evaporating away the solvent, while kneading the mixture, and drying the residue. Upon evaporating off the solvent and drying the residue, it is preferable to carry out vacuum suction. Also, a dispersion prepared by dispersing a flaky pigment in a solution previously prepared by dissolving a binder in a solvent may be added to a resin powder, and the solvent may be evaporated while mixing the mixture with stirring.

The solvent for dissolving a binder having adhesion is not particularly limited. However, it is necessary that the resin powder is not allowed to be dissolved or swelled, so that it is desired that the solvent has a low boiling point. Since the resin for a powder coating generally dissolves at a temperature of from 50° to 80° C., a low-boiling point solvent capable of being distilled off at a temperature lower than a melting point of the resin is preferable. Further, it is desired that the solvent can be completely removed at a temperature within a range of from −5° to 50° C., which is a temperature suitable as a drying temperature by vacuum suction, and more preferably at a temperature within a range of from 0° to 35° C.

From the above viewpoints, it is preferable that the solvent for dissolving a binder is a solvent having a boiling point under a normal pressure within a specified range. The solvent has a boiling point under a normal pressure is preferably 28° C. or higher, from the viewpoint of safety in consideration of inflammation point which is liable to be lowered with the boiling point, and the solvent has the boiling point of preferably 130° C. or lower, from the viewpoint of preventing the powder coatings from being blocked from each other. From these viewpoints, the solvent has a boiling point under a normal pressure of preferably from 28° to 130° C., and more preferably from 60° to 110° C.

Specific examples of the solvent preferably used in the present invention include alkanes such as pentane, hexane, heptane, and octane; isoparaffins such as isopentane, isohexane, isoheptane, and isooctane; alcohols such as methanol and ethanol; organic halides such as carbon tetrachloride; water; and the like.

The amount used of the solvent for dissolving a binder is preferably 2% by weight or more, of a liquid mixture containing a resin powder, a flaky pigment, a binder, and a solvent, from the viewpoint of homogeneously mixing the binder solution with the resin powder and the flaky pigment, and the amount used of the solvent is preferably 50% by weight or less, and more preferably 20% by weight or less, from the viewpoint of fluidity. From these viewpoints, the amount used of the solvent for dissolving a binder is preferably from 2 to 50% by weight, and more preferably from 3 to 20% by weight, of the above liquid mixture.

In the kneading of the mixture including the step of removing the solvent by drying, the temperature of a kneaded mixture is preferably from −5° C. or higher, from the viewpoint of avoidance of extending the drying time to a long period of time, and the temperature is preferably 50° C. or lower, from the viewpoint of preventing the resin powders from being bound to each other. From these viewpoints, the temperature of the kneaded mixture is preferably from −5° to 50° C., and more preferably from 0° to 35° C.

The step of mixing a resin powder and a flaky pigment and the kneading and drying step subsequent thereto in which a binder is added to the mixture can be continuously carried out within the same mixer using a vacuum kneader mixer or the like. From the viewpoint of improving productivity, the mixing step and the kneading step can be alternatively separately carried out. In the latter case, a mixer which is used in the mixing step includes a normal-pressure kneader mixer, a twin-screw kneader, a Henschel mixer, a high-speed mixer such as a Super Mixer, a blender, and the like. The kneading-and-drying apparatus used in the kneading and drying step includes a vibration dryer, a continuous fluidized bed dryer, and the like.

The powder coating in which a flaky pigment is bound to a surface of a resin powder via a binder having adhesion has an average particle size of preferably from 5 to 100 μm, from the viewpoint of coating workability and smoothness of a coating film. On the other hand, it is preferable that the powder coating usually has an average particle size of less than 25 μm, from the viewpoint of mixing two or more powder coatings having different hues from each other, thereby toning a powder coating composition to a homogenous hue. By contrast, when a powder coating composition from which a coating film having brightness is obtained as in the present invention is prepared, a coating film having a homogeneous hue can be formed even when the powder coating has an average particle size of 25 μm or more. In addition, the powder coating has an average particle size of more preferably 50 μm or less, from the viewpoint of the smoothness of the coating film. From these viewpoints, it is more preferable that each powder coating has an average particle size of from 25 to 50 μm.

In addition, a difference in specific gravities between each of powder coatings is preferably 0.7 or less, and more preferably 0.3 or less, from the viewpoint of homogeneous mixing of the powder coatings.

The powder coating composition of the present invention obtained by mixing two or more powder coatings is obtained by dry-blending with a known mixer at least two powder coatings having different hues from each other mentioned above, in which a flaky pigment is bound to a surface of a resin powder via a binder having adhesion. In addition to the powder coatings, it is preferable that a powder coating in which a flaky pigment is bound to a surface of a resin powder without containing a colorant, i.e. a resin powder containing a resin but not containing a colorant, via a binder having adhesion (non-colored powder coating) is further mixed with the powder coatings. By adding a powder coating without containing a colorant, only brightness can be adjusted without affecting the hue of the powder coating composition.

The non-colored powder coating can be produced in the same manner as the above powder coating except that a colorant is not used.

A powder coating composition of the present invention is obtained by mixing with various mixers at least two powder coating having different hues from each other, and an optionally used non-colored powder coating. The amount of each of the powder coatings to be formulated is properly determined by taking into consideration hues and brightness that are desired in the powder coating composition.

A coating film can be obtained by applying a powder coating composition of the present invention to an object to be coated (substrate), and heating the coated substrate. The object to be coated is not particularly limited, and those that are not subjected to deformation, modification or the like by stoving are preferred. The preferred object to be coated includes known metals such as iron, copper, aluminum, and titanium; various alloys thereof; and the like.

The method of applying a powder coating composition of the present invention is preferably carried out by the steps of previously subjecting an applied surface to a blast treatment, subjecting the treated surface to a known treatment such as chemical synthesis treatment to adhere the powder coating composition thereto, and thermally curing the adhered coating. The above chemical synthesis treatment is preferably a non-chromate treatment from the aspect of environmental protection, and includes a zirconium treatment, and the like.

As the method of applying a powder coating composition of the present invention to a surface of an object to be coated, a known method such as a spray-coating method, a fluidized bed dip coating method, or an electrostatic powder coating method can be applied, and the electrostatic powder coating method is preferred from the viewpoint of efficiency of coating adhesion. The electrostatic powder coating method includes a corona discharge method, a triboelectric charge method, and the like.

The conditions for thermally curing a powder coating composition of the present invention differ depending upon the functional groups partaking in the curing and the amount of the curing accelerator. For example, the heating temperature is preferably from 100° to 230° C., more preferably from 140° to 200° C., and even more preferably from 150° to 180° C. The heating time can be properly set depending upon the heating temperature, and the heating time is generally 1 minute or longer, and more preferably from 5 to 30 minutes.

The thickness of the coating film formed by a powder coating composition of the present invention is not particularly limited. It is preferable that the thickness of the coating film formed by thermal curing is set so as to have a thickness of from 20 to 200 μm or so.

### EXAMPLES

The present invention will be described more specifically hereinbelow by means of Examples, without intending to limit the scope of the present invention thereto.

### Production Example 1 of Powder Coating

Sixty parts by weight of a polyester resin “Finedic M-8034” (commercially available from DAINIPPON INK AND CHEMICALS, INCORPORATED), 3 parts by weight of an epoxy resin “EPOTOHTO NT-114” (commercially available from Tohto Kasei Co., Ltd.), 10 parts by weight of a curing agent “IPDI Adduct B-1530” (commercially available from Degussa (formerly known as Huels AG), ε-caprolactam blocked isocyanate), 0.5 parts by weight of benzoin, and 9.62 parts by weight of an extender “Precipitated Barium Sulfate-100” (commercially available from Sakai Chemical Industry Co., Ltd.) were mixed with a Henschel mixer, and the mixture was melt-kneaded with an extruder. The kneaded mixture was cooled, pulverized, and then classified, to give a resin powder A0. The average particle size of the resulting resin powder was determined. As a result, the average particle size was 35 μm. Here, the average particle size was a value obtained by calculating a volume average from a particle size distribution determined with a measurement apparatus “MICRO TRAC HRA X-100” (commercially available from NIKKISO Co., Ltd.) and an analyzing program “MICRO TRAC D.H.S. X100 Data Handling System SD-9300 PRO-100” (commercially available from NIKKISO Co., Ltd.) under the measurement conditions in which “Particle Transparency” is set at “reflect.”

Fifty grams of the resulting resin powder, 2 g of aluminum flakes “PCF7601A” (commercially available from TOYO ALUMINUM K.K., average particle size: 33.7 μm), and 0.5 g of aluminum flakes “PCF7160A” (commercially available from TOYO ALUMINUM K.K., average particle size: 16.3 μm) were sufficiently dry-blended, and thereafter a 200-ml tightly sealed glass bottle-type high-speed blender (commercially available from PHOENIX) was charged with the resulting blended mixture.

Next, a solution prepared by dissolving 1.5 g of a terpene phenolic hydrogenated resin “YS POLYSTAR TH-130” (commercially available from YASUHARA CHEMICAL CO., LTD., number-average molecular weight: 800, softening temperature: 130° C.), as a binder having adhesion, in 10 g of normal heptane (boiling point: 98.4° C.) was added the mixture charged in the high-speed blender. The mixture was sufficiently kneaded so that the mixture becomes homogeneous with a spatula. While continuing the kneading of the mixture, the kneaded mixture was air-dried for about 1 hour, to give powder with powder dust. Here, the number-average molecular weight is a value determined by gel permeation chromatography (GPC, a conversion value as polystyrene). In addition, the softening temperature is a value determined by a differential scanning calorimetric measurement (DSC).

The air-dried powder was transferred to a 1-liter eggplant-shaped flask, and further subjected to vacuum drying with an evaporator at an ambient temperature for 20 minutes, while rotating and mixing the contents. After the vacuum drying, the powder in the eggplant-shaped was observed. It was found that aggregated lumps were not present, so that pulverization was not especially carried out. The resulting powder was sieved with a screen having a screen opening of 106 μm, to give a clear (non-colored) powder coating A1. The average particle size of the resulting powder coating was determined in the same manner as in the resin powder. As a result, the average particle size was 36 μm. In addition, the powder coating had a specific gravity of 1.3. Here, the specific gravity was a value determined by a method in accordance with JIS Z8807.

The resulting powder coating was applied to a tinplate having dimensions of 300 mm×400 mm×0.3 mm with an electrostatic spray apparatus so as to form a cured film having a thickness of 50 to 80 μm, and the coated tinplate was introduced into a stoving drying furnace set at 180° C. and stoved for 20 minutes to cure the coating, to give a coating film of a metallic effect. The resulting coating film was subjected to colorimetry with a “SM Color Computer SM-7” (Color Computer commercially available from SUGA TEST INSTRUMENTS Co., Ltd., measured pore: 30 mmφ (diameter)). As a result, an L value was 50.02, an a value was −0.35, and a b value was −1.33.

### Production Example 2 of Powder Coating

The same procedures as in Production Example 1 were carried out except that 5 parts by weight of a colorant “CR-90” (commercially available from ISHIHARA SANGYO KAISHA, LTD.) and 4.62 parts by weight of “Precipitated Barium Sulfate-100” were used in place of 9.62 parts by weight of “Precipitated Barium Sulfate-100,” to give a resin powder B0 having an average particle size of 35 μm. The resin powder B0 was further mixed with aluminum flakes, to give a white powder coating B1 having an average particle size of 36 μm and a specific gravity of 1.29.

Further, a coating film was formed using the resulting powder coating, and the coating film was subjected to colorimetry. The resulting film had an L value of 57.47, an a value of −0.4, and a b value of −2.79.

### Production Example 3 of Powder Coating

The same procedures as in Production Example 1 were carried out except that 0.125 parts by weight of a colorant “FW-200P” (commercially available from Degussa) and 9.495 parts by weight of “Precipitated Barium Sulfate-100” were used in place of 9.62 parts by weight of “Precipitated Barium Sulfate-100,” to give a resin powder C0 having an average particle size of 35 μm. The resin powder C0 was further mixed with aluminum flakes, to give a black powder coating C1 having an average particle size of 36 μm and a specific gravity of 1.29.

Further, a coating film was formed using the resulting powder coating, and the coating film was subjected to colorimetry. The resulting film had an L value of 41.05, an a value of 0.05, and a b value of −0.23.

### Production Example 4 of Powder Coating

The same procedures as in Production Example 1 were carried out except that 0.88 parts by weight of a colorant “TODA COLOR 130ED” (commercially available from Toda Kogyo Corporation, ferric oxide) and 8.74 parts by weight of “Precipitated Barium Sulfate-100” were used in place of 9.62 parts by weight of “Precipitated Barium Sulfate-100,” to give a resin powder D0 having an average particle size of 35 μm. The resin powder D0 was further mixed with aluminum flakes, to give a red powder coating D1 having an average particle size of 36 μm and a specific gravity of 1.29.

Further, a coating film was formed using the resulting powder coating, and the coating film was subjected to colorimetry. The resulting film showed a pearl-like tone, and had an L value of 44.32, an a value of 4.48, and a b value of 1.51.

### Production Example 5 of Powder Coating

The same procedures as in Production Example 1 were carried out except that 0.5 parts by weight of a colorant “FASTOGEN Blue NK” (commercially available from DAINIPPON INK AND CHEMICALS, INCORPORATED, copper phthalocyanine) and 9.12 parts by weight of “Precipitated Barium Sulfate-100” were used in place of 9.62 parts by weight of “Precipitated Barium Sulfate-100,” to give a resin powder E0 having an average particle size of 35 μm. The resin powder E0 was further mixed with aluminum flakes, to give a blue powder coating E1 having an average particle size of 36 μm and a specific gravity of 1.29.

Further, a coating film was formed using the resulting powder coating, and the coating film was subjected to colorimetry. The resulting film had an L value of 42.14, an a value of −2.21, and a b value of −9.92.

### Production Example 6 of Powder Coating

The same procedures as in Production Example 1 were carried out except that 2.5 parts by weight of a colorant “HY-100” (commercially available from Titanium Industry Co., Ltd., yellow iron oxide) and 7.12 parts by weight of “Precipitated Barium Sulfate-100” were used in place of 9.62 parts by weight of “Precipitated Barium Sulfate-100,” to give a resin powder F0 having an average particle size of 35 μm. The resin powder F0 was further mixed with aluminum flakes, to give a yellow powder coating F1 having an average particle size of 36 μm and a specific gravity of 1.29.

Further, a coating film was formed using the resulting powder coating, and the coating film was subjected to colorimetry. The resulting film had an L value of 48.27, an a value of −0.55, and a b value of 6.70.

### Production Example 7 of Powder Coating

The same procedures as in Production Example 1 were carried out except that 2.5 g of mica flakes “Iriodin 103WNT” (commercially available from Merck Ltd. Japan, average particle size: 18.1 μm) were used in place of the aluminum flakes, to give a resin powder having an average particle size of 35 μm. Further, a clear (non-colored) powder coating A2 having an average particle size of 36 μm and a specific gravity of 1.3 was obtained.

Further, a coating film was formed using the resulting powder coating, and the coating film was subjected to colorimetry. The resulting film had an L value of 66.99, an a value of −1.23, and a b value of 0.71.

### Examples 1 to 12 and Comparative Examples 1 and 2

Powder coatings in a weight ratio shown in Table 1 were mixed with a Super Mixer (commercially available from Nihon Spindle Manufacturing Co., Ltd.) for 2 minutes. The resulting powder coating composition was applied to a tinplate having dimensions of 300 mm×400 mm×0.3 mm with an electrostatic coater so as to form a cured film having a thickness of 50 to 80 μm, and the coated tinplate was introduced into a stoving drying furnace set at 180° C. and stoved for 20 minutes to cure the coating, to give a coating film.

### Comparative Example 3

Powder coatings in a weight ratio shown in Table 1 were mixed with aluminum flakes “PCF7601A” (commercially available from TOYO ALUMINUM K.K., average particle size: 33.7 μm) in a 1:1 weight ratio, and the mixture was mixed in a Super Mixer (Nihon Spindle Manufacturing Co., Ltd.) for 2 minutes. The resulting powder coating composition was applied to a tinplate having dimensions of 300 mm×400 mm×0.3 mm with an electrostatic coater so as to form a cured film having a thickness of 50 to 80 μm, and the coated tinplate was introduced into a stoving drying furnace set at 180° C. and stoved for 20 minutes to cure the coating, to give a coating film.

The metallic effect, the unevenness, and the appearance of the coating films obtained in Examples and Comparative Examples were visually observed, and evaluated in accordance with the following evaluation criteria. The results are shown in Table 1.

### [Metallic Effect]

The metallic effect of the coating film was evaluated by brightness and unevenness of aluminum (due to unevenness in alignment).

### ◯: The brightness is excellent, and no unevenness of aluminum is not found.

### Δ: The brightness is low, and slight unevenness of aluminum is found.

### X: No brightness is found.

### [Unevenness]

A monitor with an eyesight vision of 1.5 visually observed the coated plate 2 m away from the plate. The unevenness of the coating film was evaluated from floating.

### ◯: No unevenness in color is found at all.

### Δ: Slight unevenness in color is found.

### X: Unevenness in color is found on an entire coating film.

### [Appearance]

A coated plate after coating and stoving was evaluated for an L value an a value, and a b value with a calorimeter “SM Color Computer SM-7” (Color Computer commercially available from SUGA TEST INSTRUMENTS Co., Ltd., measured pore: 30 mmφ).

### ◯: At least one of absolute values of the a value or the b value is 1 or more, and has color.

### X: Both of absolute values of the a value and the b value are less than 1, and does not have color.

TABLE 1

| | Powder Coatings | | | | | | | | | | |
|---|---|---|---|---|---|---|---|---|---|---|---|
| | A1 | B1 | C1 | D1 | E1 | F1 | A2 | B0 | C0 | D0 | E0 |
| | (Clear) | (White) | (Black) | (Red) | (Blue) | (Yellow) | (Mica) | (Black) | (White) | (Red) | (Blue) |
| Ex. 1 | — | 50 | — | — | — | 50 | — | — | — | — | — |
| Ex. 2 | — | 50 | — | 50 | — | — | — | — | — | — | — |
| Ex. 3 | — | — | 50 | — | — | 50 | — | — | — | — | — |
| Ex. 4 | — | — | 50 | 50 | — | — | — | — | — | — | — |
| Ex. 5 | — | — | — | 50 | — | 50 | — | — | — | — | — |
| Ex. 6 | — | — | 50 | — | 50 | — | — | — | — | — | — |
| Ex. 7 | 50 | 20 | — | — | — | 30 | — | — | — | — | — |
| Ex. 8 | 50 | — | 30 | 20 | — | — | — | — | — | — | — |
| Ex. 9 | — | — | — | — | — | 50 | 50 | — | — | — | — |
| Ex. 10 | — | — | — | 50 | — | — | 50 | — | — | — | — |
| Ex. 11 | — | 20 | — | 80 | — | — | — | — | — | — | — |
| Ex. 12 | — | 20 | — | — | — | 80 | — | — | — | — | — |
| Comp. | — | — | — | — | — | — | — | 50 | 50 | — | — |
| Ex. 1 | | | | | | | | | | | |
| Comp. | — | — | — | — | — | — | — | — | — | 50 | 50 |
| Ex. 2 | | | | | | | | | | | |
| Comp. | — | — | — | — | — | — | — | — | 50 | 50 | — |
| Ex. 3 | | | | | | | | | | | |

| | Evaluation of Coating Film | | | | | |
|---|---|---|---|---|---|---|
| | Metallic | | | L | a | b |
| | Effect | Unevenness | Appearance | Value | Value | Value |
| Ex. 1 | ∘ | ∘ | ∘ | 42.96 | −0.21 | 3.92 |
| Ex. 2 | ∘ | ∘ | ∘ | 41.56 | 2.02 | 1.69 |
| Ex. 3 | ∘ | ∘ | ∘ | 53.60 | −1.28 | 7.28 |
| Ex. 4 | ∘ | ∘ | ∘ | 49.60 | 3.92 | 1.77 |
| Ex. 5 | ∘ | ∘ | ∘ | 45.12 | 4.66 | 6.48 |
| Ex. 6 | ∘ | ∘ | ∘ | 47.30 | −2.86 | −9.22 |
| Ex. 7 | ∘ | ∘ | ∘ | 49.16 | −0.43 | 12.03 |
| Ex. 8 | ∘ | ∘ | ∘ | 43.25 | 6.61 | 3.78 |
| Ex. 9 | ∘ | ∘ | ∘ | 50.02 | −0.39 | 11.18 |
| Ex. 10 | ∘ | ∘ | ∘ | 44.56 | 7.30 | 3.95 |
| Ex. 11 | ∘ | ∘ | ∘ | 41.52 | 0.88 | 1.13 |
| Ex. 12 | ∘ | ∘ | ∘ | 41.85 | −0.25 | 2.14 |
| Comp. | x | x | x | 45.75 | −0.38 | 0.47 |
| Ex. 1 | | | | | | |
| Comp. | x | x | ∘ | 12.58 | 2.95 | 0.71 |
| Ex. 2 | | | | | | |
| Comp. | ∘ | x | ∘ | 47.94 | 11.96 | 6.72 |
| Ex. 3 | | | | | | |

| | |
|---|---|
| Note | 1) Amount of the powder coating used is expressed by parts by weight. |
| | 2) In the powder coatings, B0 to E0 are resin powders B0 to E0 obtained in the process |
| | of producing the powder coatings B1 to E1, respectively. |

It can be seen from the above results that in all of Examples 1 to 12, coating films having metallic effect, not having unevenness, and having excellent appearance are obtained. Here, in Examples 9 and 10, coating films having both metallic effect and pearl effect are obtained. On the other hand, it can be seen that coating films obtained in Comparative Examples 1 and 2 in which a flaky pigment is not used do not have metallic effect, and have marked unevenness, and that a coating film obtained in Comparative Example 3 in which a flaky pigment is mixed with a powder coating, without allowing the flaky pigment to adhere to the surface of a resin powder of the powder coating, and has unevenness even has metallic effect.

The powder coating composition of the present invention is suitably used in coatings of automobile parts, electric appliances, furniture, engineering work machines, office equipments, toys, and the like, and a method for producing the powder coating composition.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for producing a powder coating composition comprising mixing two or more powder coatings, wherein at least two powder coatings out of the two or more powder coatings have different hues from each other, and wherein each of the two powder coating comprises a flaky pigment bound to a surface of a resin powder comprising a resin and a colorant via a binder having adhesion.

2. The method according to claim 1, wherein the two or more powder coatings comprise a powder coating comprises a flaky pigment bound to a surface of a resin powder without containing a colorant via a binder having adhesion.

3. The method according to claim 1, wherein the flaky pigment is made of at least one member selected from the group consisting of metals, mica, and glass.

4. The method according to claim 3, wherein the flaky pigment is a metallic flake.

5. The method according to claim 4, wherein the metallic flake is an aluminum flake.

6. The method according to claim 3, wherein the flaky pigment is a mica flake or glass flake.

7. The method according to claim 1, wherein the two or more powder coatings comprise a powder coating in which a flaky pigment made of a metal is bound to a surface of a resin powder, and a powder coating in which a flaky pigment made of mica or glass is bound to a surface of a resin powder.

8. The method according to claim 1, wherein the two or more powder coatings have an average particle size of from 25 to 50 μm.

9. The method according to claim 1, wherein a difference in specific gravities between each of the two or more powder coatings is 0.7 or less.

10. A powder coating composition comprising two or more powder coatings, wherein at least two powder coatings out of the two or more powder coatings have different hues from each other, and wherein each of the two powder coating comprises a flaky pigment bound to a surface of a resin powder comprising a resin and a colorant via a binder having adhesion.
